(19) United States
(12) Patent Application Publication
(10) Pub. No.: US 2013/0234085 A1
(43) Pub. Date: Sep. 12, 2013

(54) FISH-TAPE PUSHING TOOL

(71) Applicant: Doug Dickie, Huntington Beach, CA (US)

(72) Inventor: Doug Dickie, Huntington Beach, CA (US)

(21) Appl. No.: 13/418,199

(22) Filed: Mar. 12, 2012

(51) Int. Cl. H02G 1/08

(52) U.S. Cl. 254/134.3 R

(57) ABSTRACT

A Fish-tape Pushing Tool. The tool preferably includes an input shaft that can be inserted into the chuck of a conventional hammer drill or impact driver tool. The device is defined by a groove formed through it sized to accept a conventional fish tape therewithin. When the hammer drill is set to create longitudinal oscillations, it causes the pushing tool to also oscillate. The oscillations of the pushing tool will cause unidirectional teeth within the groove to intermittently grasp the fish tape and incrementally push it down the groove, whereby the user will be able to feed the pulsatingly advancing fish tape through a conduit or along other confined path. The tool is designed to be simple, small and easy to handle for the user.

### BACKGROUND OF THE INVENTION

1. Field of the Invention

This invention relates generally to hand power tools and accessories therefore and, more specifically, to a Fish-tape Pushing Tool.

2. Description of Related Art

One common tool used in residential and commercial construction is known as a “fish tape.” A fish tape is a device used to pre-thread wiring, cabling and even piping through walls, floors, ceilings and the like. An example of a conventional fish tape assembly 10 is depicted in FIG. 1.

The assembly 10 has a hollow storage handle 12, within which a coiled fish tape 14 is held. The tape 14 is generally made from metal, although fiberglass tapes 14 have recently been released to the market. The storage handle 12 can be designed to dispense the tape 14 in a variety of ways. In certain designs, the storage handle 12 is split around its outer edge—the tape 14 is dispensed (and recoiled) through the split. In other cases, such as that shown, the fish tape 14 is dispensed and recoiled through a central split or aperture. In any design choice, the function of the tape 14 is the same. The tape 14 is threaded through a hole or gap in a wall, or even through a section of electrical conduit, etc. until it protrudes at the other end. The protruding end of the tape 14 can then be used to back-feed wire through the hole, gap, conduit, etc. by attaching the wire to the tape 14 and then pulling the tape 14 back out (i.e. pulling using the storage handle 12 and usually recoiling the tape 14 at the same time).

The tape 14 is stiff and has a certain “springiness” to it, which makes it much better for threading through holes, gaps and the like, than the final wiring would be—particularly for long or complicated runs. That being said, for particularly difficult runs, such as crowded sections of conduit, the tape 14 becomes very difficult to push through, and is very susceptible to getting caught or jammed in the conduit, etc. In recognition of this propensity, certain fish tape pushing devices have been introduced over the years. One such device is depicted in FIG. 2.

FIG. 2 is a perspective view of a Power Drive Fish Tape device patented by Bob Brennan, and which is the subject of U.S. Pat. No. 6,361,021. The Brennan power driven fish tape 16 has an internal rotating ring 17 that, when rotated, will either cause the fish tape 14 to pay out of the housing 18 or be recoiled therein through the handle 20. This paying out or recoiling can be done either manually, or with assistance of a conventional drill 24. If the user attached the drill 24 to the input shaft 22, the drill 24 can be used to rotate the input shaft 22, which in turn will cause the internal ring 17 to rotate to either pay out or reel in the tape 14.

While the Brennan device seems to be functional to pay out and reel in the tape 14, it fails to perform one specific feature—it does not agitate the tape 14 while paying it out. Many times a stuck tape 14 can be freed by push-pulling in rapid succession. This push-pull operation would be very difficult to be conducted by the drill 24 using the Brennan device because the user's hands are full, and because the lack of torque that the user can impart on the tape 14 because of the physical orientation of the devices.

Another fish tape pushing/pulling device was the subject of U.S. Patent Application Publication 2002/0066893, filed by Quinn. Like the Brennan device, the Quinn feed mechanism can push or pull a fish tape, but it does not generate any pulsating movement to free a stuck (or avoid sticking) a fish tape. Similarly, U.S. Pat. No. 3,220,700 discloses a power drive for a conventional “electrician's snake.” This patent to H. N. Comeau, like those devices of the Brennan and Quinn disclosures, does not provide pulsating movement.

Numerous devices do not add power drive capability to a conventional fish tape, but rather replace the fish tape assembly altogether. That is to say that the mechanism has an integral fish tape. Examples of these types of mechanisms are disclosed by Atencio, U.S. Pat. No. 6,722,603, G. Botello et al., U.S. Pat. No. 3,355,148, Wilson, U.S. Pat. No. 4,917,362, Passoni, U.S. Pat. No. 3,610,582, W. E. Raney, U.S. Pat. No. 2,556,484 and Fisher et al. U.S. Patent Application Publication No. 2002/0008130. Like the previously-described add-on devices, these “integrated tape” devices also fail to generate pulsing or driving motion. By failing to provide a pulsing motion, all of these devices fail to utilize the best proven way to prevent jamming of a tape in a crowded conduit and the like. Furthermore, these integrated tape-type dispensers a quite a bit more complex than those that utilize conventional fish tape assemblies, and therefore they tend to be prohibitively expensive (and therefore not really economically feasible).

What is needed is a device that provides power driving capability to a conventional fish tape by pushing the tape using pulsing motion.

### SUMMARY OF THE INVENTION

In light of the aforementioned problems associated with the prior devices and accessories, it is an object of the present invention to provide a Fish-tape Pushing Tool. The tool should include an input shaft that can be inserted into the chuck of a conventional hammer drill or impact driver tool. The device should be provided with a groove formed through it sized to accept a conventional fish tape therewithin. When the hammer drill is set to create longitudinal oscillations, it should cause the pushing tool to also oscillate. The oscillations of the pushing tool should cause unidirectional teeth within the groove to intermittently grasp the fish tape and incrementally push it down the groove, whereby the user will be able to feed the pulsatingly advancing fish tape through a conduit or along other confined path. The tool should be simple, small and easy to handle for the user.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional fish tape;

FIG. 2 is a perspective view of a Power Drive Fish Tape device patented by Bob Brennan;

FIG. 3 is a perspective view of a preferred embodiment of the fish tape pushing tool of the present invention and a conventional hammer drill;

FIG. 4 is a perspective view of the device and hammer drill of FIG. 3 in operation to push a fish tape;

FIGS. 5A and 5B are side and cutaway side views, respectively, of the tool of FIGS. 3 and 4; and

FIG. 6 is a partial side view of the groove area of the tool of FIGS. 3, 4 and 5A.

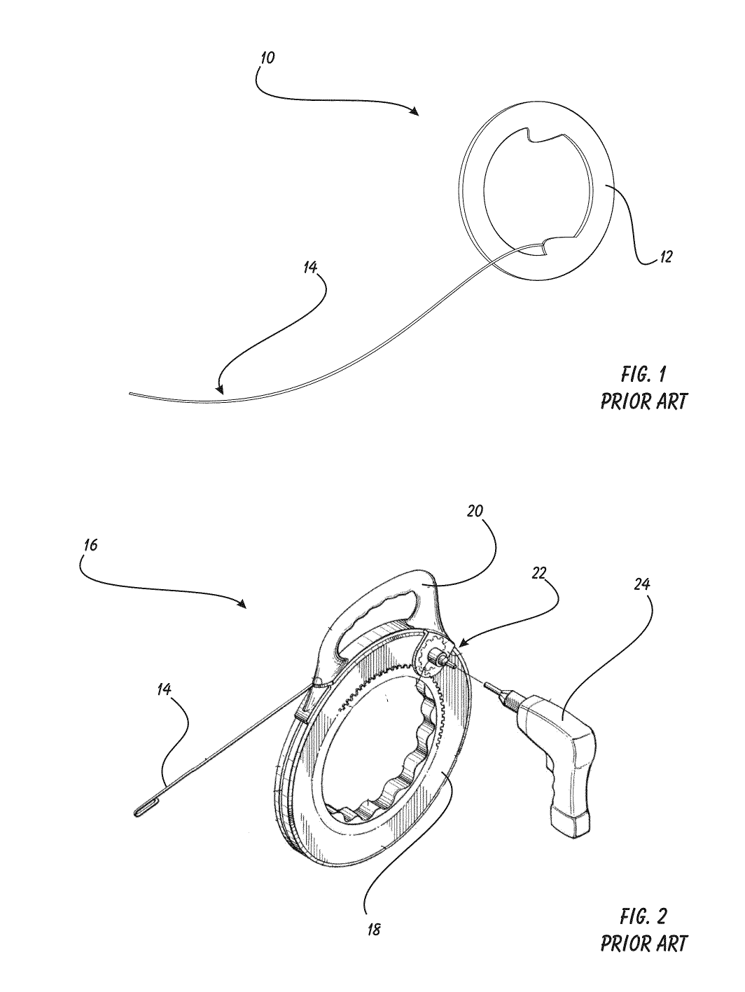

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Fish-tape Pushing Tool.

The present invention can best be understood by initial consideration of FIG. 3. FIG. 3 is a perspective view of a preferred embodiment of the fish tape pushing tool 30 of the present invention and a conventional hammer drill 38. The tool 30 is depicted as being generally cylindrical in shape, which has been found to be a desirable form, however other versions are also contemplated.

The tool 30 is defined by an outer housing 32 having an arcuate groove 34 formed in it. The housing 32 has an input shaft 36 extending from it. The shaft 36 is sized to be insertible into the conventional bore 42 of the chuck 40 (shaft holder) of the hammer drill 38. The outer housing 32 could be made from aluminum, steel, or even durable plastic depending upon the particular version and application for the tool 30.

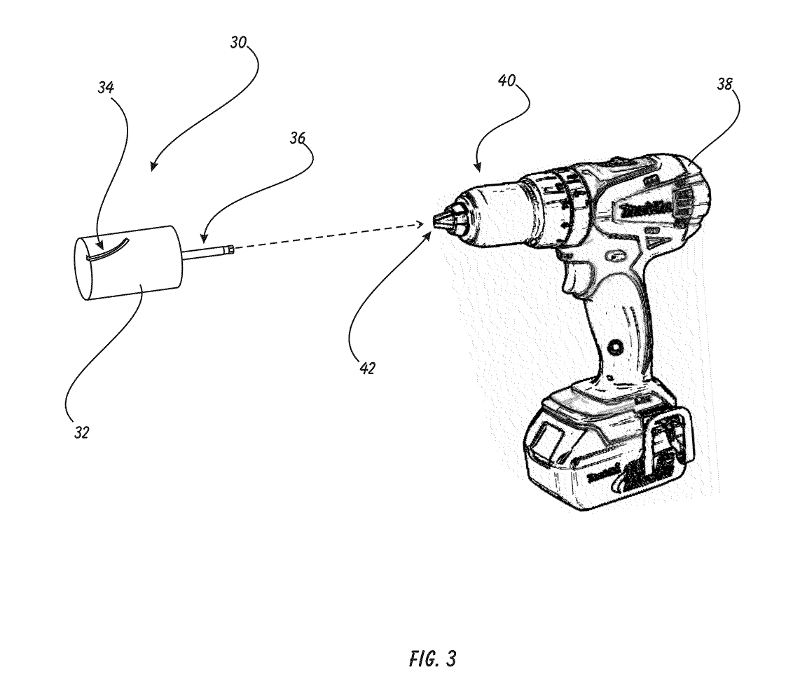

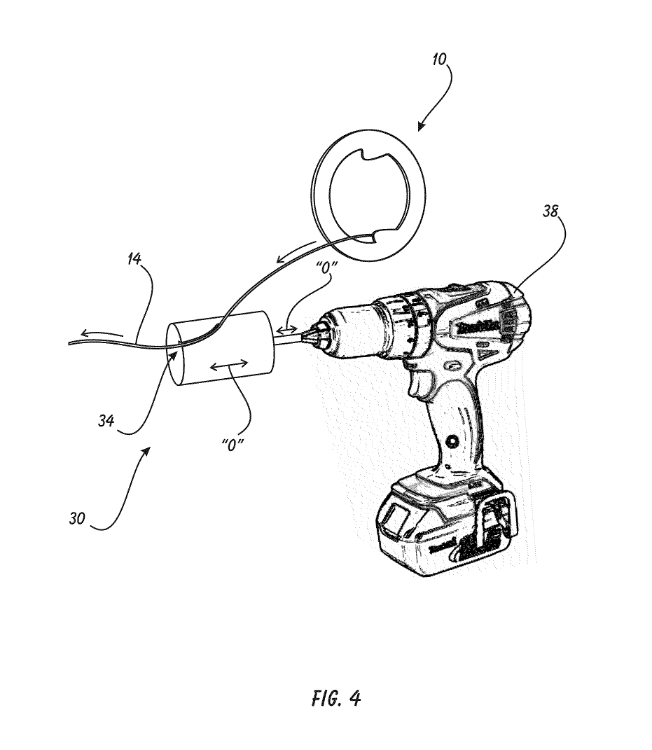

Hammer drills are somewhat specialized devices that are particularly suitable for basic drilling functions, but have an additional strength in that they will provide a “hammering” motion to the drill bit inserted into the bore 42. This hammering (in and out) movement, combined with rotation of the drill, is particularly intended for drilling into extremely hard materials, such as concrete and plaster and the like. While hammer drills are known for use in concrete drilling roles, the inventor is unaware of their use in connection with the feeding or handling of fish tapes. FIG. 4 provides additional detail regarding the functioning of the tool 30.

FIG. 4 is a perspective view of the device 30 and hammer drill 38 of FIG. 3 in operation to push a fish tape. The input shaft 36 has been captured within the chuck 40 bore. For operation with the instant invention, the hammer drill 38 is set so that it will transmit rotational as well as hammering movement to the input shaft 36. The rotational movement is signified by direction “R” in this depiction, and it could be in either clockwise or counterclockwise direction. The hammering movement generated by the drill 38 is of an oscillating, translating nature, and is depicted as “O” in this drawing figure.

The oscillating motion “O” is translated through the input shaft to the housing 32 of the device 30. The groove 34 formed in the housing 32 is configured, as will be discussed more fully below, to push a fish tape 14 inserted therein in direction “F” as the device 30 is oscillating back and forth in direction “O.” As the tape 14 pulsed in direction “F,” the user simple feeds additional tape 14 into the groove 34. Since the groove 34 is open on its outer side, it is very easy for the user to insert the tape 14 into the groove 34 before commencing to feed the tape 14. Similarly, it is equally as easy to remove the tape 14 from the groove 34 when the tape 14 has been fed to the desired distance.

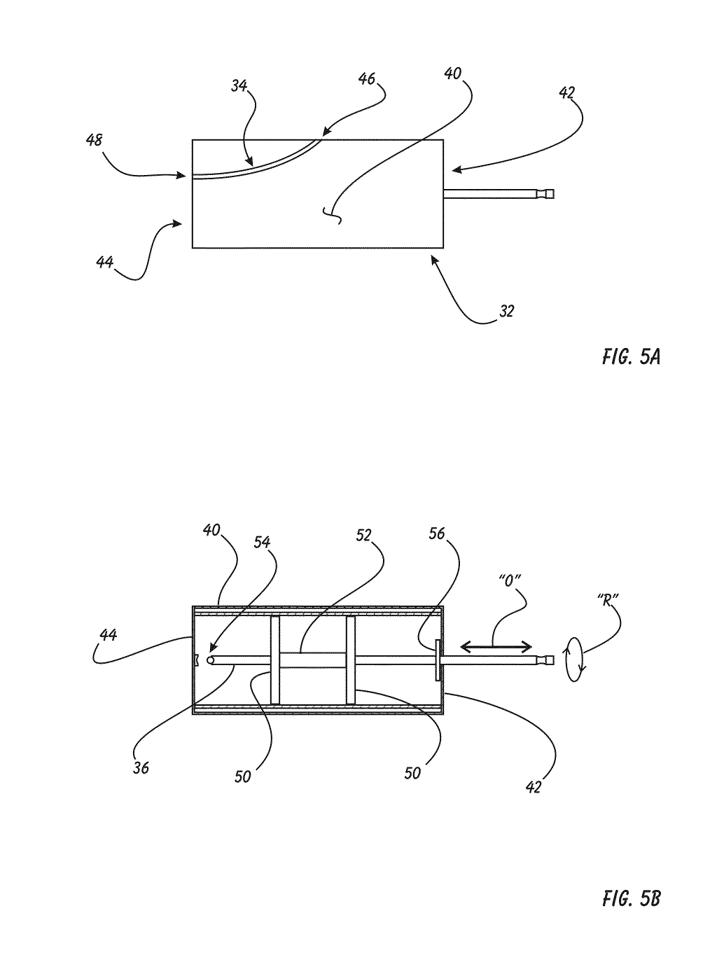

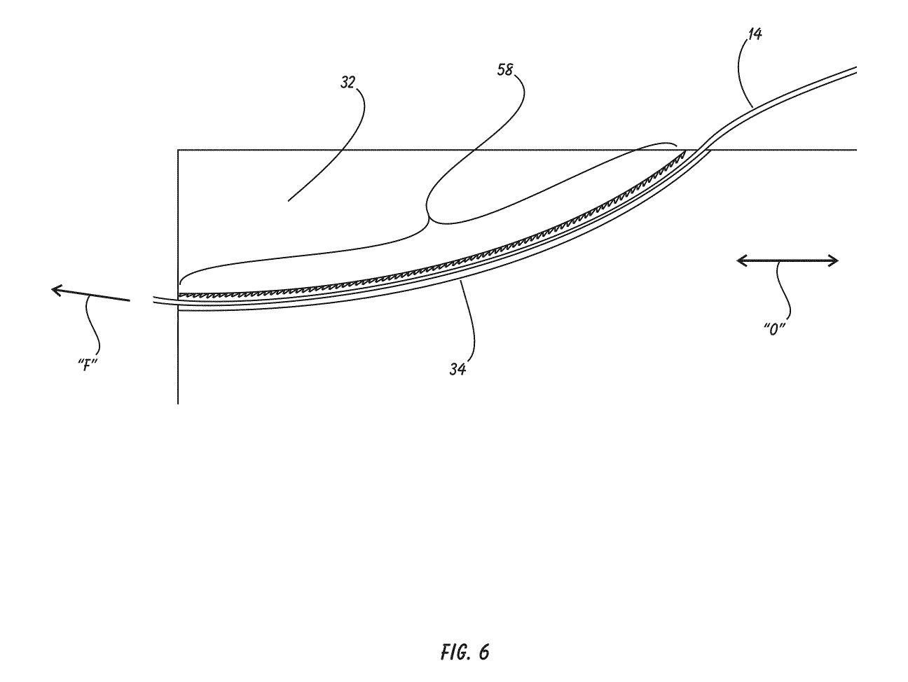

It should be noted (as will be explained below) that while the housing 32 does oscillate back and forth in direction “O,” it does not rotate in direction “R,” since this would defeat the user's ability to feed the tape 14. The input shaft 36 is permitted to rotate relative to the outer housing 32, but while doing so, the shaft 36 is held in an axial (translational) direction such that any motion by the shaft 36 in direction “O” will result in the same motion by the housing 32. FIGS. 5A and 5B depict additional design features of this novel device.

FIGS. 5A and 5B are side and cutaway side views, respectively, of the tool 30 of FIGS. 3 and 4. The outer housing 32 is defined by a generally cylindrical outer wall 40, a proximal wall (through which the input shaft 36 passes), and a distal wall 44 at its opposing end. The outer wall 40 has an arcuate (curved or arched) groove 34 formed in its side. The groove 34 is open on its outwardly-facing side, as discussed previously, to permit the insertion and removal of a fish tape.

The groove 34 has an entrance opening 46 in the outer wall 40. The entrance opening 46 can be positioned atop the housing 32, or the housing 32 could be rotated so that the opening 46 is on the bottom or side, as desired. The opposing end of the groove 34 terminates at the distal wall 44 in an exit opening 48 therethrough. The tape 14 being fed by the device 30 exits the exit opening 48 as the device 30 is pulsed in a longitudinal direction by the hammer drill.

On its interior, a variety of different designs are possible, so long as the input shaft 36 is allowed to rotate freely relative to the housing 32, while being prevented from any such relative motion in direction “O.” In the depicted version, there are a pair of support discs 50 in spaced relation along the internal length of the inner chamber formed by the housing 32. In fact a second shell has been incorporated into this design so that a fully-assembled set of internal components could be inserted into a hollow outer housing 32 after which the proximal wall 42 need only be attached thereto in order to finish the assembly of the device 30. In alternate (non-depicted) forms, only a single (32) housing design will be employed.

A bearing sleeve 52 interconnects the two support discs. The input shaft passes through the length of the housing 32 and through the support discs 50 and bearing sleeve 52. There are one or more bearing sets housed within the sleeve 52 to allow the shaft 36 to rotate freely therein. The input shaft 36 has a rounded tip 54 to allow the end of the shaft 36 to press against the distal wall 44 (an possibly a cup-like depression formed therein as shown) when the oscillating hammering force is applied. The tip 54 could also be a ball bearing that rotates within a socket formed in the end of the input shaft 36. In its proper form, there would be no gap between the tip 54 and the distal wall 44. The end plate 56 serves to seal the aperture formed in the proximal wall 42 (through which the input shaft 36 passes), as well as to assist in the transfer of oscillating motion “O” from the input shaft 36 and the housing 32. Finally, we shall turn to FIG. 6 to examine the particulars of the groove design.

FIG. 6 is a partial side view of the groove area of the tool of FIGS. 3, 4 and 5A. The groove 34 preferably is formed with three closed sides and one open side. The open side facilitates the insertion and removal of the fish tape 14 from the groove 34. The upper wall of the groove 34 is formed with “one-way” teeth 58 extending downwardly. The term “one-way” is intended to convey that the teeth have a positive rake angle, and that all of the rake angles of all of the teeth are oriented in one direction (i.e. to the left in this view). These teeth 58 is dispersed within the groove 34, and will allow the fish tape 14 to move in direction “F” (to the left in this view), but will engage the tape 14, and therefore prevent its movement in the opposite direction. The curved shape of the groove 34 serves three purposes: first, it makes the feeding of the tape 14 through it tend to be smoother. Second, the curvature tends to assist the teeth 58 in grasping the tape 14 when the housing 32 is moving in direction “F.” Finally, the curved shape tends to release the tape 14 from the teeth 58 when the housing 32 is moved in the direction opposite to “F.” The result is that the tool 30 will push the tape in a smooth, repetitive, incrementally small set of movements in direction “F.” These small movements make it easy to handle the tool 30, while also feeding the tape 14 through a conduit (for example) very effectively.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A tool, comprising:
a cylindrical housing having an arcuate groove extending between an end wall and a sidewall formed therein; and
an input shaft extending from a second end wall defined by said housing, said input shaft attached to said housing to permit rotational motion therebetween, but to restrict relative longitudinal motion therebetween.

2. The tool of claim 1, further comprising teeth extending into the internal volume formed in said groove.

3. The tool of claim 2, wherein the rake angle defined by each of said teeth is positive and in the same direction as the other said teeth.

4. The tool of claim 3, wherein said groove wherein said arcuate shape defines an outer wall, an inner wall and a sidewall, said inner and outer walls defining generally parallel relative shapes and the radius of said arc of said outer wall being greater than the radius of said arc of said inner wall.

5. The tool of claim 4, wherein said teeth are dispersed along said inner wall.

6. The tool of claim 5, further comprising a pair of support discs contained within an internal chamber formed in said housing, said support discs attached to said sidewall and further defining a central aperture formed therethrough, said input shaft passing through said central apertures.

7. An attachment for a hammer drill, the hammer drill defining a chuck bore and selectively generating rotational and translation motion therein, the attachment comprising:
an input shaft configured to be insertible in said chuck bore;
an outer housing defining a distal end and a proximal end, said input shaft extending from said proximal end;
an arcuate groove formed in said outer housing; and
attachment means for attaching said input shaft to said outer housing, said attachment means permitting relative rotational movement between said outer housing and said input shaft but restricting relative translation movement between said outer housing and said input shaft.

8. The attachment of claim 7, wherein said groove is defined by three closed sides and one side open through said outer housing.

9. The attachment of claim 8, wherein said groove wherein said arcuate shape defines an outer wall, an inner wall and a sidewall, said inner and outer walls defining generally parallel relative shapes and the radius of said arc of said outer wall being greater than the radius of said arc of said inner wall.

10. The attachment of claim 9, further comprising teeth extending into the internal volume formed in said groove.

11. The attachment of claim 10, wherein said teeth are dispersed along said inner wall.

12. The attachment of claim 11, wherein the rake angle defined by each of said teeth is positive and in the same direction as the other said teeth.

13. A fish tape pushing tool, comprising:
a housing having a external wall and defining an internal chamber; and
a groove formed in said housing, said groove comprising an elongate bore formed in said external wall and defined by an opening extending the length of said groove.

14. The tool of claim 13, further comprising an input shaft extending from said housing, said input shaft rotatingly attached to said housing.

15. The tool of claim 14, wherein said groove is defined by three closed sides and one side open through said outer housing.

16. The tool of claim 15, wherein said groove wherein said arcuate shape defines an outer wall, an inner wall and a sidewall, said inner and outer walls defining generally parallel relative shapes and the radius of said arc of said outer wall being greater than the radius of said arc of said inner wall.

17. The tool of claim 16, further comprising teeth extending into the internal volume formed in said groove.

18. The tool of claim 17, wherein said teeth are dispersed along said inner wall.

19. The tool of claim 18, wherein the rake angle defined by each of said teeth is positive and in the same direction as the other said teeth.

20. The tool of claim 19, further comprising attachment means for attaching said input shaft to said outer housing, said attachment means permitting relative rotational movement between said housing and said input shaft but restricting relative translation movement between said outer housing and said input shaft.
